(19) United States
(12) Patent Application Publication
(10) Pub. No.: US 2014/0139035 A1
(43) Pub. Date: May 22, 2014

(54) WIRELESS POWER TRANSMISSION CONTROLLER, POWER TRANSMITTING DEVICE, POWER RECEIVING DEVICE AND WIRELESS POWER TRANSMITTING SYSTEM

(71) Applicant: KABUSHIKI KAISHA TOSHIBA, Tokyo (JP)

(72) Inventors: Hiroaki ISHIHARA, Kawasaki-Shi (JP); Kohei ONIZUKA, Tokyo (JP); Fumi MORITSUKA, Kawasaki-Shi (JP); Shoji OTAKA, Yokohama-Shi (JP)

(21) Appl. No.: 14/078,200

(22) Filed: Nov. 12, 2013

(30) Foreign Application Priority Data
Nov. 19, 2012 (JP) 2012-253490

(51) Int. Cl. H04B 5/00

(52) U.S. Cl. CPC H04B 5/0037
USPC 307/104

(57) ABSTRACT

There is provided a wireless power transmission controller in which the input device receives first power information from a power transmitting device, indicating electric power transmitted by the power transmitting device, and second power information from a power receiving device, indicating electric power received by the power receiving device, the output device outputs a first control signal instructing a transmission voltage of the power transmitting device, and a second control signal instructing an impedance of the power receiving device, the control device performs raising control of transmission power of the power transmitting device by generating the second control signal so that a difference between the first and second power information becomes small, and generates the first control signal so that a difference between the first power information and a first target value or a difference between the second power information and a second target value becomes small.

### CROSS REFERENCE TO RELATED APPLICATIONS

This application is based upon and claims the benefit of priority from the prior Japanese Patent Application No. 2012-253490, filed on Nov. 19, 2012, the entire contents of which are incorporated herein by reference.

### FIELD

Embodiments described herein relate to a wireless power transmission controller, a power transmitting device, a power receiving device and a wireless power transmitting system.

### BACKGROUND

In the wireless power transmission technology, it is known that the transmission efficiency of electric power varies depending on various parameters such as impedances of a load, a power supply unit, and a power receiving unit, and a transmission distance. Here, the transmission efficiency (or simply the efficiency) is defined as a ratio of power supplied from a power supply at a power transmitting side to a power which is received at a power receiving side.

When wireless power transmission is performed, it is desirable to set the impedance at a power receiving side at a suitable value and start up a power transmitting side. When the impedance is not set at a suitable value, a sufficient efficiency is not obtained, and loss is likely to be increased with increase of power.

The method has been conventionally disclosed, which realizes transmission of large electric power with a high efficiency by performing adjustment of impedance matching with low electric power, and thereafter, shifting to power transmission with large electric power.

In the above described conventional art, concerning the parameters which do not depend on the amount of power which is transmitted, or have small amounts of dependency, the impedance can be set at a suitable value by adjustment in low electric power. However, when a parameter that depends on the electric power which is transmitted is present, if adjustment is performed with low electric power, and thereafter, power transmission is shifted to large electric power, the parameter varies, and therefore, there is the possibility that the impedance deviates from a suitable value and a sufficient efficiency cannot be obtained. For example, when connection is made with a battery as a load, the impedance of the battery significantly varies in response to electric power that is supplied to the battery.

### BRIEF DESCRIPTION OF THE DRAWINGS

FIG. 1 is a block diagram of a wireless power transmission controller according to an embodiment;

FIG. 2 is a diagram showing a system example (1) according to an embodiment;

FIG. 3 is a diagram showing a system example (2) according to an embodiment;

FIG. 4 is a diagram showing an operation flow example of the wireless power transmission controller according to an embodiment;

FIG. 5 is a diagram showing a configuration example of a power transmitting unit;

FIG. 6 is a diagram showing a configuration example of a power receiving unit;

FIG. 7 is a diagram showing a connection example of a power management unit;

FIG. 8 is a diagram showing an example of a temporal change of power and an efficiency;

FIG. 9 is a diagram showing an operation flow example that uses a current and a voltage to make determination;

FIGS. 10A and 10B are a diagram showing an operation flow example of changing a change step size in response to loss information;

FIGS. 11A and 11B are a chart showing an operation flow example of changing the change step size in response to a ratio of a transmission power and a target power;

FIG. 12 is a diagram showing an operation flow example including determination of initial values of transmission voltage instruction information and power receiving side impedance instruction information;

FIG. 13 is a chart showing an operation flow example in a case of performing re-execution by changing the change step size at a time of failure;

FIG. 14 is a diagram showing a configuration example of a wireless power transmission controller having an abnormality detection input;

FIG. 15 is a diagram showing a configuration example of a wireless power transmission controller in a case of being used in bidirectional transmission;

FIGS. 16A and 16B are a diagram showing a configuration example of a bidirectional transmitting system;

FIG. 17 is a diagram showing a modification example of a wireless power transmission controller according to an embodiment;

FIG. 18 is a diagram showing another modification example of the wireless power transmission controller according to an embodiment; and

FIG. 19 is a diagram showing still another modification example of the wireless power transmission controller according to an embodiment.

### DETAILED DESCRIPTION

There is provided a wireless power transmission controller, including: an input device, an output device and a control device.

The input device receives first power information from a power transmitting device, the first power information indicating electric power transmitted by the power transmitting device, and second power information from a power receiving device, the second power information indicating electric power received by the power receiving device.

The output device outputs a first control signal that instructs a transmission voltage of the power transmitting device, and a second control signal that instructs an impedance of the power receiving device.

The control device performs raising control of transmission power of the power transmitting device by generating the second control signal and the first control signal.

The control device generates the second control signal so that a difference between the first power information and the second power information becomes small, and generates the first control signal so that a difference between the first power information and a first target value or a difference between the second power information and a second target value becomes small.

Hereinafter, embodiments will be described in detail with reference to the drawings.

### First Embodiment

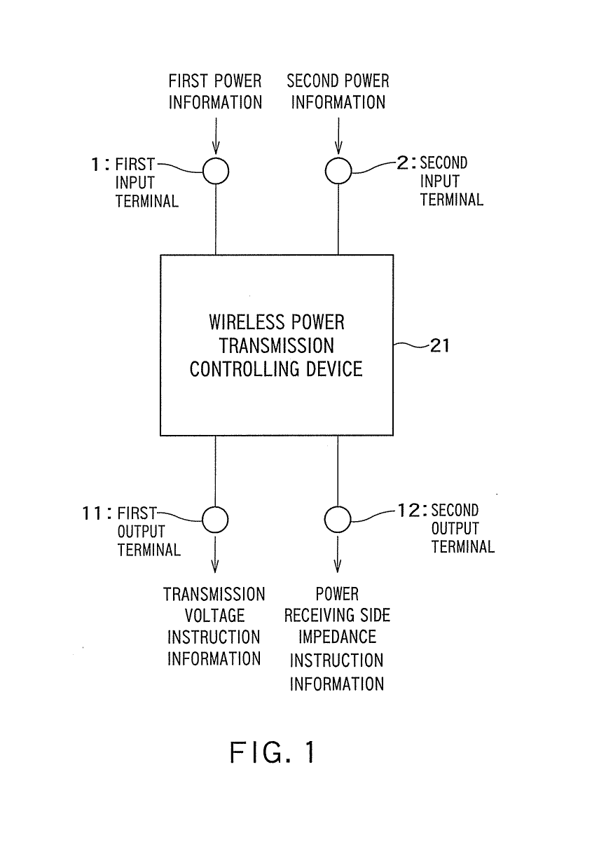

FIG. 1 shows a configuration of a wireless power transmission controller according to the present embodiment. The present controller relates to a technique of estimating a transmission efficiency of electric power, and a technique of controlling the transmission efficiency to a high value irrespective of transmission conditions such as a transmission distance and an impedance of a load.

The wireless power transmission controller of FIG. 1 includes a first input terminal 1 and a second input terminal 2 as an input device, a first output terminal 11 and a second output terminal 12 as an output device, and a wireless power transmission controlling device 21. The wireless power transmission controlling device 21 may be simply called a control device

The first input terminal 1 receives first power information (transmission power information) indicating electric power that is sent out from a power transmitting side. The second input terminal 2 receives second power information (reception power information) indicating electric power that is received at a power receiving side. The first output terminal 11 outputs a first control signal (transmission voltage instruction information) that instructs a transmission voltage at the power transmitting side. The second output terminal 12 outputs a second control signal (power receiving side impedance instruction information) that instructs an impedance of a power receiving side.

The wireless power transmission controlling device 21 performs raising control of the transmission power at the power transmitting side. The wireless power transmission controlling device 21 generates the second control signal (power receiving side impedance instruction information) so that a difference between the first power information and the second power information becomes small.

Further, the wireless power transmission controlling device 21 generates the first control signal (transmission voltage instruction information) so as to make the first power information close to a first target value, or so as to make the second power information close to a second target value. Namely, the wireless power transmission controlling device 21 generates the first control signal (transmission voltage instruction information) so that a difference of the first power information and the first target value becomes small, or so that a difference of the second power information and the second target value becomes small.

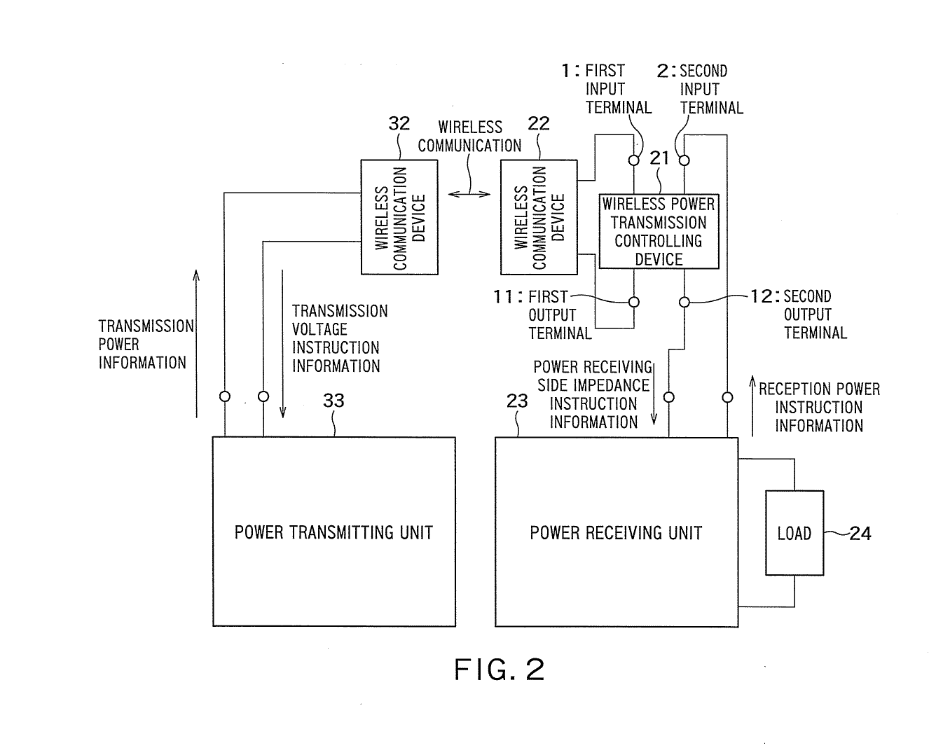

FIG. 2 shows a wireless power transmitting system according to the present embodiment.

The present system includes a power transmitting device, and a power receiving device.

The power receiving device includes the wireless power transmission controlling device 21, the first input terminal 1, the second input terminal 2, the first output terminal 11, the second output terminal 12, a wireless communicating device 22, a power receiving unit 23, and a load 24. The wireless power transmission controlling device 21 has the same configuration as the wireless power transmission controller shown in FIG. 1.

The power transmitting device is a wireless power transmitting device that includes a wireless communicating device 32 and a power transmitting unit 33.

The power transmitting unit 33 has a device that changes a transmission voltage in response to the first control signal (transmission voltage instruction information). The power receiving unit 23 has a device that changes the impedance of the power receiving unit in view of the power transmitting side in response to the second control signal (power receiving side impedance instruction information).

The power transmitting unit 33, and the first input terminal 1 and the first output terminal 11 are connected by radio via the wireless communicating devices 22 and 32. The power receiving unit 23, and the second input terminal 2 and the second output terminal 12 are connected by wire.

The wireless power transmission controlling device 21 receives the first power information (transmission power information) from the power transmitting side with the first input terminal 1 via the wireless communicating devices 32 and 22, and receives the second power information (reception power information) with the second input terminal 2 from the power receiving unit 23. The wireless power transmission controlling device 21 transmits the transmission voltage instruction information to the power transmitting side via the wireless communicating devices 32 and 22 from the first output terminal 11, and outputs the power receiving side impedance instruction information to the power receiving unit 23 from the second output terminal 12.

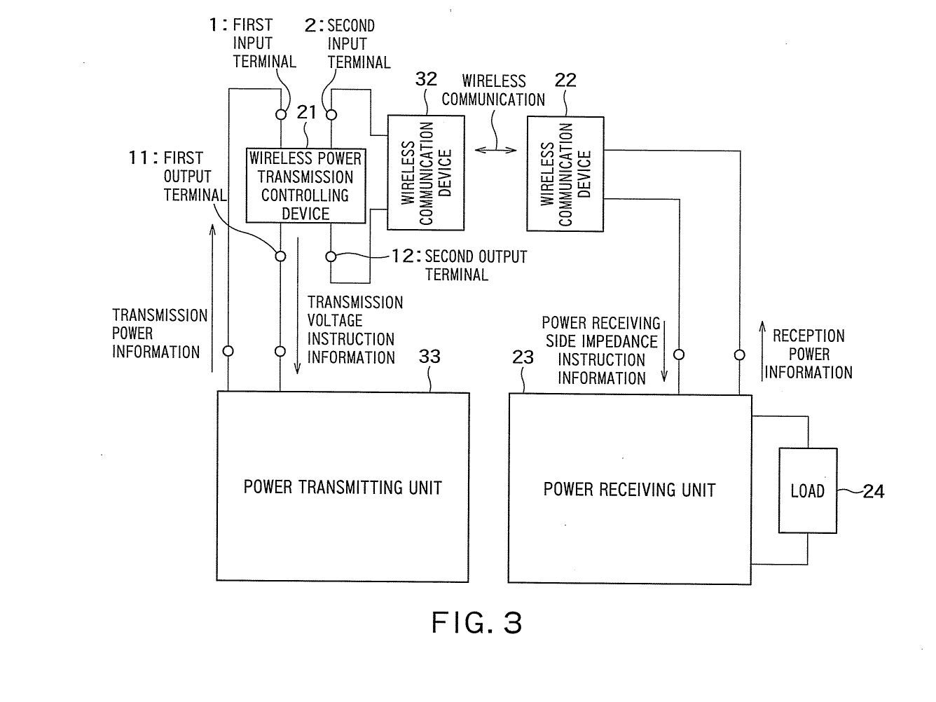

In FIG. 2, the wireless power transmission controlling device is provided at the power receiving side, but may be provided at the power transmitting side. FIG. 3 shows a system configuration in which the wireless power transmission controlling device is provided at the power transmitting side. The system of FIG. 3 shows a power transmitting device including a wireless power transmission controlling device, and a power receiving device. The elements with the same names as in FIG. 2 are assigned with the same reference signs.

The power transmitting unit 33, and the first input terminal 1 and the first output terminal 11 are respectively connected by wire. The power receiving unit 23, and the second input terminal 2 and the second output terminal 12 are connected by radio via the wireless communicating devices 32 and 22.

Further, the wireless power transmission controlling device may be configured as an independent device separated from the power transmitting device and the power receiving device, though not illustrated.

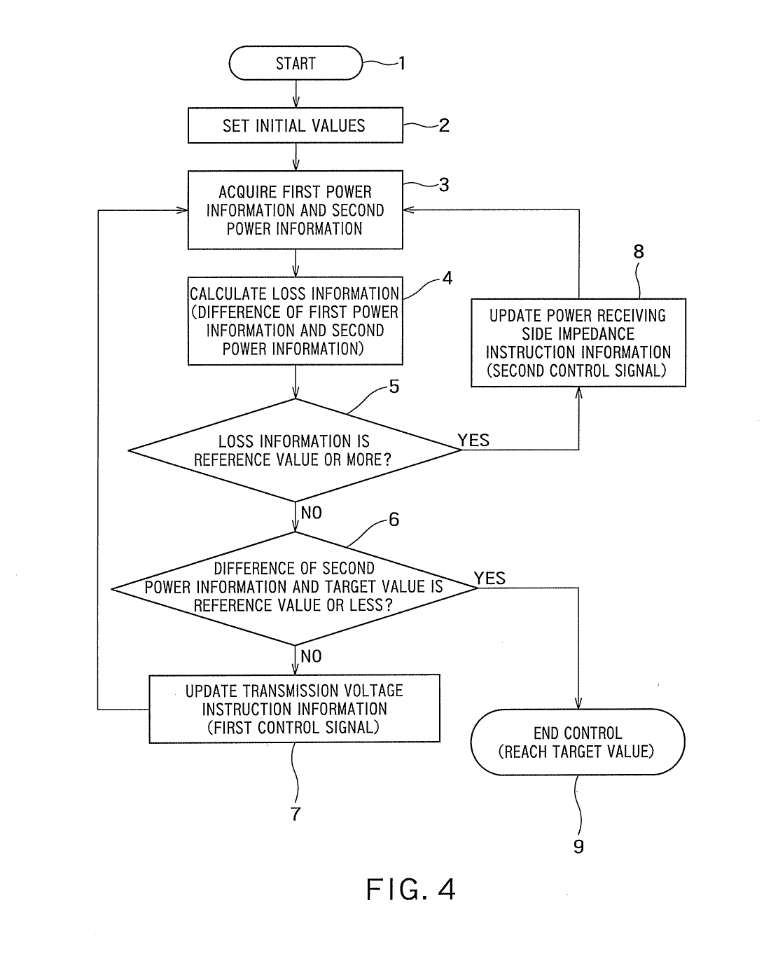

FIG. 4 shows an operation flow of start up of the power transmitting device by the wireless power transmission controlling device 21.

At a time of start of power transmission (step 1), the first control signal which instructs the transmission voltage of the power transmitting device, and the second control signal which instructs the impedance of the power receiving side are both set at initial values (step 2).

Next, acquisition of the first power information and the second power information which are the information of the transmission power and the information of the reception power at the power transmitting side and the power receiving side is performed (step 3).

The acquired power information is inputted in the wireless power transmission controlling device 21 respectively from the first input terminal 1 and the second input terminal 2.

The wireless power transmission controlling device 21 changes the second control signal (power receiving side impedance instruction information) so that a differential of the two kinds of power information which are inputted becomes small. More specifically, loss information is derived by finding the difference of the two kinds of power information (step 4), and if the loss information is a reference value or more (YES in step 5), the second control signal is changed so that the loss information becomes small (step 8). After the change, the acquiring operation of the above described two kinds of power information is performed again. A method for changing the second control signal may be an optional method. For example, with a predetermined step size (change amount), the second control signal can be increased or decreased. Here, the loss information is acquired by the differential of the two kinds of power information, but a different method may be used. For example, a table in which two kinds of power amount information and loss information are matched with one another is prepared, and by referring to the table, the loss information may be acquired. Note that calculation of the loss information is not indispensable, and an optional method can be used, as long as the method is for changing the second control signal so that the differential of the two kinds of power information becomes small.

When the loss information is less than the reference value (NO in step 5), the first control signal (power transmitting side voltage instruction information) is updated so as to make at least one of the first power information and the second power information close to the target value. First, at least one of the first power information and the second power information is compared with the target value (step 6). The example of FIG. 4 shows the case of comparing the second power information with the target value, but the first power information may be used. Alternatively, both the first power information and the second power information may be respectively compared with each reference value. If a relationship of the second power information and the target value is a predetermined relationship (YES in step 6), the raising control is ended (step 9).

Here, the predetermined relationship is, for example, the reception power information (second power information) being the target value or more, an absolute value of the difference from the target value being a predetermined value or less, or the like. Similar determination may be performed with use of the transmission power information (first power information). Determination may be performed with use of the result of comparing the respective transmission power information and reception power information with respective target values. After the raising control is ended, the flow may shift to a different control operation, or the operation of control is stopped and the operation may be transferred to another control device. For example, while the transmission power is kept, the parameter of any one of the power transmitting unit and the power receiving unit is swept in order to enhance the power efficiency more, and the conditions under which the efficiency is enhanced may be searched for. Further, the control may be shifted to control that keeps the transmission power constant.

When the first or the second power information and the target value do not satisfy the predetermined relationship (NO in step 6), the first control signal (transmission voltage instruction information) which instructs the power transmitting side voltage is changed. For example, if the first or the second power information is smaller than the target value, the first control signal is changed so that the transmission voltage increases to increase the power. If the first or the second power information is larger than the target value, the first control signal is changed so that the transmission voltage decreases in order to decrease the power. After the first control signal is changed, the acquisition operation of the above described two kinds of power information is repeated again. As for the method which changes the first control signal, the first control signal can be increased or decreased by a predetermined step size, for example.

Note that though not illustrated in FIG. 4, a proper stand-by time is desirably provided until the first and the second power information is acquired again after the first control signal or the second control signal is changed.

Further, in step 8 that changes the second control signal, the method of changing the second control signal can be the following method. For example, the initial value is set at a maximum value, and when the second control signal is changed, the second control signal is changed by a predetermined step size sequentially to a small side. Alternatively, the initial value is set at a minimum value conversely, and when the second control signal is changed, the second control signal is changed by a predetermined step size sequentially to a large side. Besides, any method may be used as long as the method can change the second control signal comprehensively.

In the above described operation, the first or the second power information may be the information of a current or a voltage or both of them when the power can be estimated indirectly from the current or the voltage, other than the information indicating the power itself.

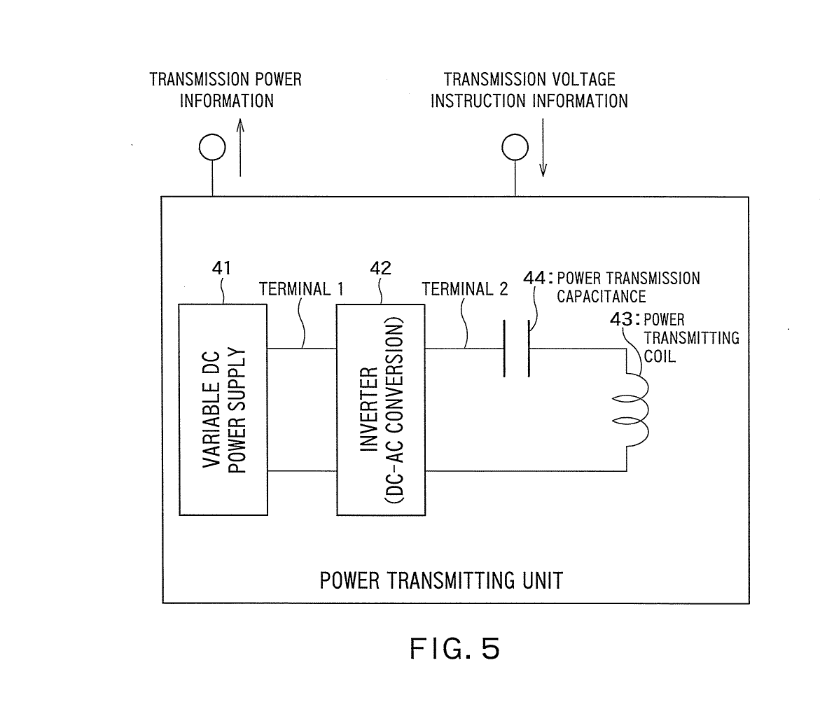

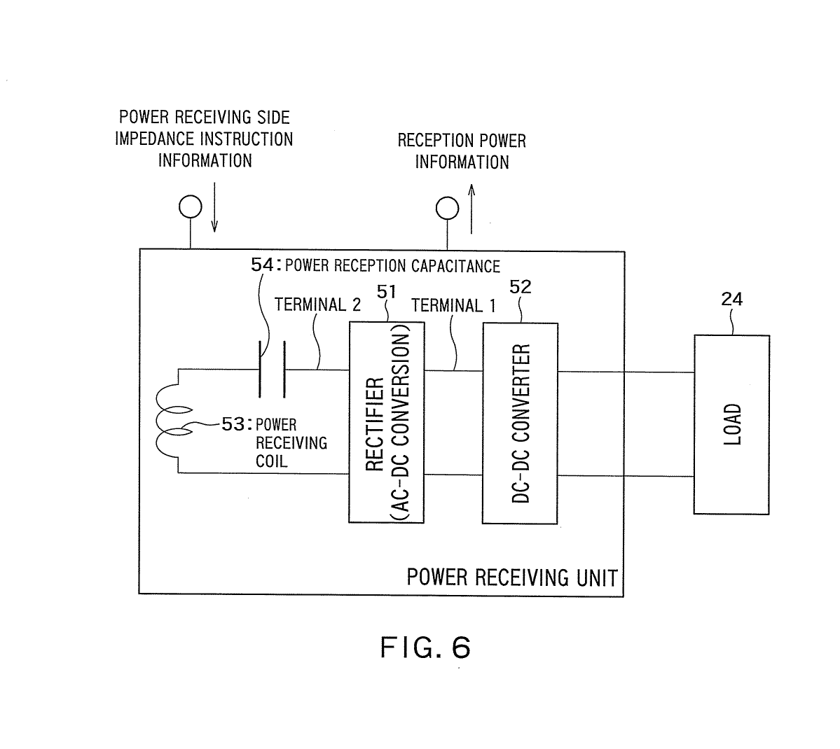

FIG. 5 shows a specific example of the power transmitting unit 33, and FIG. 6 shows a specific example of the power receiving unit 23.

The power transmitting unit 33 includes a variable DC voltage source 41, an inverter (DC-AC converting circuit) 42, a power transmitting coil 43 and a capacitance 44. The power transmitting coil 43 and the capacitance 44 are connected in series. However, the coil and the capacitance may be connected in parallel. Alternatively, a plurality of capacitances are used, and the capacitances may be respectively connected to the coil in series and parallel. As the variable DC voltage source 41, an optional configuration can be used, as long as the device can generate a variable DC. For example, the variable DC voltage source 41 may be an AC-DC converting device that is connected to an AC source. Alternatively, the variable DC voltage source 41 may include the AC-DC converting device which is connected to the AC source, and a DC-DC converting device that is disposed at an output side thereof. Alternatively, the variable DC voltage source 41 may include the AC-DC converting device connected to the AC source, an AC-AC converting device that is disposed at the output side of the AC-DC converting device, and an AC-DC converting device that is disposed at an output side of the AC-AC converting device. The variable DC voltage source 41 may include the AC source.

A spot where the first power information (transmission power information) is acquired may be an optional spot in the power transmitting unit. For example, the transmission power information may be information using any one of power, a current and a voltage of DC that can be measured in the terminal 1 between the variable DC voltage source 41 and the inverter 42 of FIG. 5. Alternatively, the transmission power information may be information using any one of power, a current and a voltage of AC that can be measured in the terminal 2 between the inverter 42 and the power transmission capacitance 44.

A configuration that makes the power transmission voltage variable by the first control signal may be realized by changing the voltage value of the variable DC voltage source 41. Alternatively, the configuration may be realized by adjusting the waveform of the AC signal of an output of the inverter 42. For example, an equivalent output amplitude of the transmission voltage may be adjusted by, changing a duty of a control signal that is inputted in the inverter 42, or changing a phase relationship of the control signal. Alternatively, a combination thereof may be used.

The power receiving unit shown in FIG. 6 includes a rectifier (AC-DC converting circuit) 51, a DC-DC convertor 52, a power receiving coil 53 and a capacitance 54. The power receiving coil 53 and the capacitance 54 are connected in series. However, the coil and the capacitance may be connected in parallel, similarly to the power transmitting unit. Alternatively, a plurality of capacitances are used, and the capacitances may be respectively connected to the coil in series and parallel. An AC-AC convertor is added to between the power reception capacitance 54 and the rectifier 51, and an output of AC that is given to the rectifier 51 may be changed.

A spot where the second power information (reception power information) is acquired may be an optional spot in the power receiving unit. For example, the reception power information may be information using any one of power, a current and a voltage of DC that can be measured in the terminal 1 between the rectifier 51 and the DC-DC convertor 52 of FIG. 6. Alternatively, the reception power information may be information using any one of power, a current and a voltage of AC that can be measured in the terminal 2 between the power reception capacitance 54 and the rectifier 51.

A configuration that makes an impedance to the load 24 variable in response to the second control signal can be realized by changing a conversion ratio of the DC-DC converting circuit 52 in the configuration of FIG. 6. In the case of the present configuration, the impedance to the load 24 is converted with a value corresponding to the conversion ratio of the DC-DC converting circuit 52. As a result, the impedance of the power receiving unit in view of the power transmitting side can be made variable.

The target value of the transmission power information or the target value of the reception power information may be a fixed value, or may be determined in accordance with the power receiving unit, or the load which is connected to the power receiving unit. For example, the target value may be set in accordance with the maximum power which the power receiving unit can allow. Alternatively, the target value may be set in accordance with the maximum power which the load can consume. Alternatively, the target value may be set in accordance with the maximum power which the power transmitting unit can supply. Further, the target value may be set in accordance with the information which is instructed by a power management system to which the power transmitting device or the power receiving device is connected. Furthermore, the target value may be determined by combining a plurality of kinds of information among them.

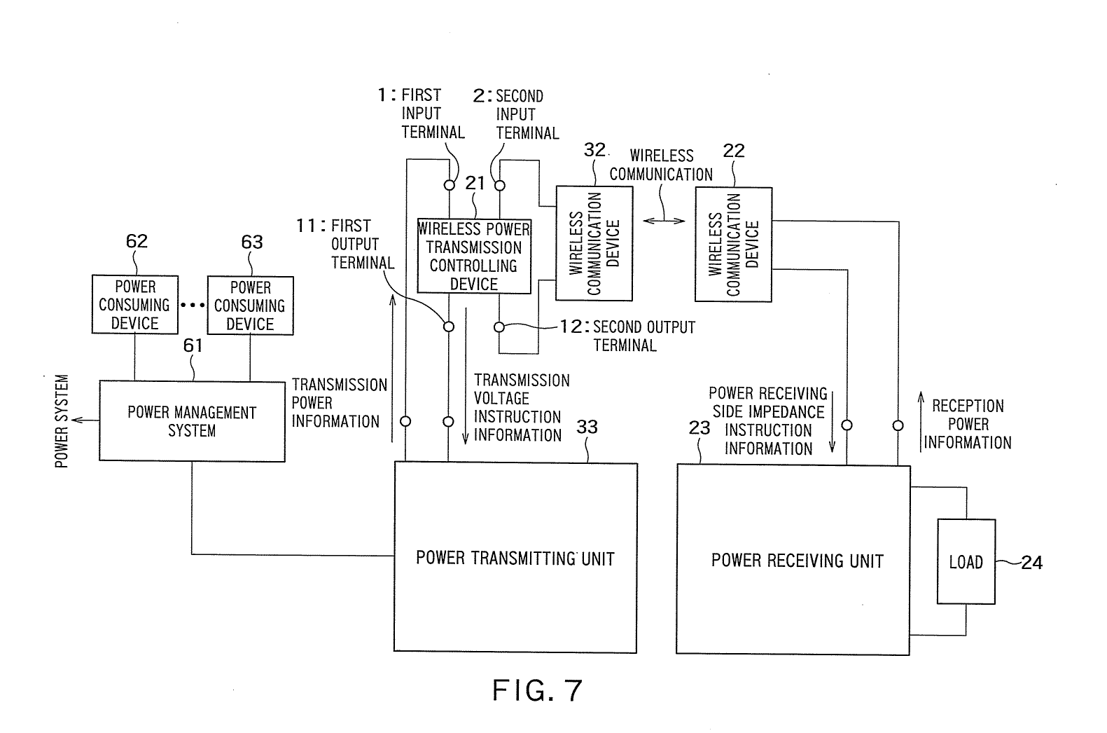

FIG. 7 shows a configuration example in which the power management system is connected to the power transmitting device. A power management system 61 may be HEMS that is disposed in a household, for example. The power management system 61 manages the power transmitting device and power use of power consuming devices 62 and 63 by using power from the system, a storage battery or the like. The power management system 61 transmits information instructing the above described target value to the wireless power transmission controlling device 21 of the power transmitting device by wire or by radio. FIG. 7 shows the configuration in which the power management system is connected to the power transmitting device, but the power management system may be connected to the power receiving device. In this case, the wireless power transmission controlling device may be provided at the power receiving device. The power receiving device is disposed in an automobile such as EV, for example, and the load 24 may be a storage battery.

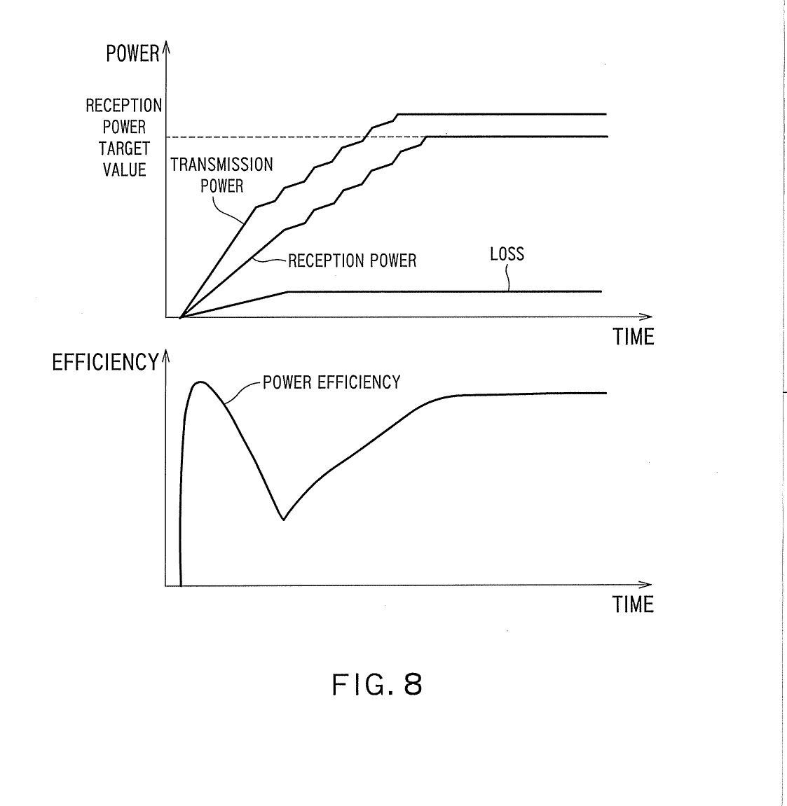

FIG. 8 shows an example of temporal changes of power, loss and an efficiency in a case of using the wireless power transmission controller according to the present embodiment. Here, a case of performing control so that a difference between the second power information (reception power) and the target value becomes small. The loss is limited to a certain degree or less, the transmission power, the reception power and the efficiency increase with time, and the reception power reaches the target value.

As above, according to the present embodiment, the power of the power transmitting device can be started up safely and reliably with low loss. Further, even when a parameter having power dependency is present, power can be raised up without exceeding a preset loss amount.

### Second Embodiment

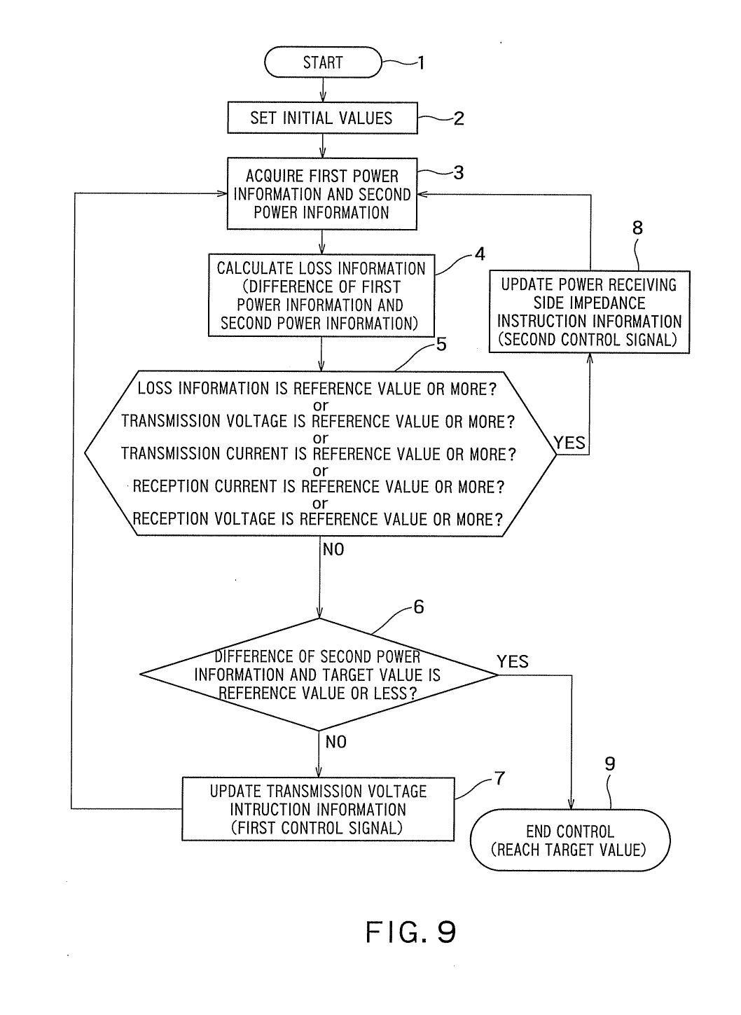

A second embodiment will be described with use of FIG. 9.

FIG. 9 shows an operation flow of a wireless power transmission controller according to the present embodiment. In the present operation flow, steps other than step 5 are similar to FIG. 4, and therefore, the description thereof will be omitted.

In the first embodiment, determination of whether to update the second control signal (receiving side impedance instruction information) is performed with only the loss information which is the difference between the first and the second power information as the reference. In contrast with this, in the present embodiment, determination is performed with use of current information and voltage information of the power transmitting unit, and current information and voltage information of the power receiving unit, in addition to the loss information, as shown in step 5 of FIG. 9.

As shown in FIG. 9, if at least any of the loss information, the current information and the voltage information of the power transmitting unit, and the current information and the voltage information of the power receiving unit is respective reference values or more, the second control signal is changed. Thereby, the raising control of transmission power (start-up of the power transmitting device) is enabled with the current and the voltage of the power transmitting side, and the current and the voltage of the power receiving side being the respective reference values or less, in addition to the loss.

Further, in accordance with necessity, only a part of these kinds of information may be used. For example, if the current amount which can be allowed by the power transmitting device or the power receiving device is sufficiently large relative to the value which the current of the power transmitting or the power receiving side can take, determination may be performed without using the current information of the power transmitting unit or the power receiving unit. Similarly, if the voltage value which can be allowed by the power transmitting device or the power receiving device is sufficiently large relative to the value which the voltage of the power transmitting or the power receiving side can take, determination may be performed without using the voltage information of the power transmitting unit or the power receiving unit.

Terminals that are used in acquiring the information of the voltage and the current may be optional terminals similarly to the power. For example, the terminal 1 and the terminal 2 shown in FIG. 5, the terminal 1 and the terminal 2 shown in FIG. 6 and the like can be used.

Note that in the operation shown above, when comparison with the reference value or the target value is performed, a reference range or a target range is used instead of the reference value or the target value, and whether in the range or out of the range may be determined. This similarly applies for the first embodiment and the other embodiments that will be described later.

### Third Embodiment

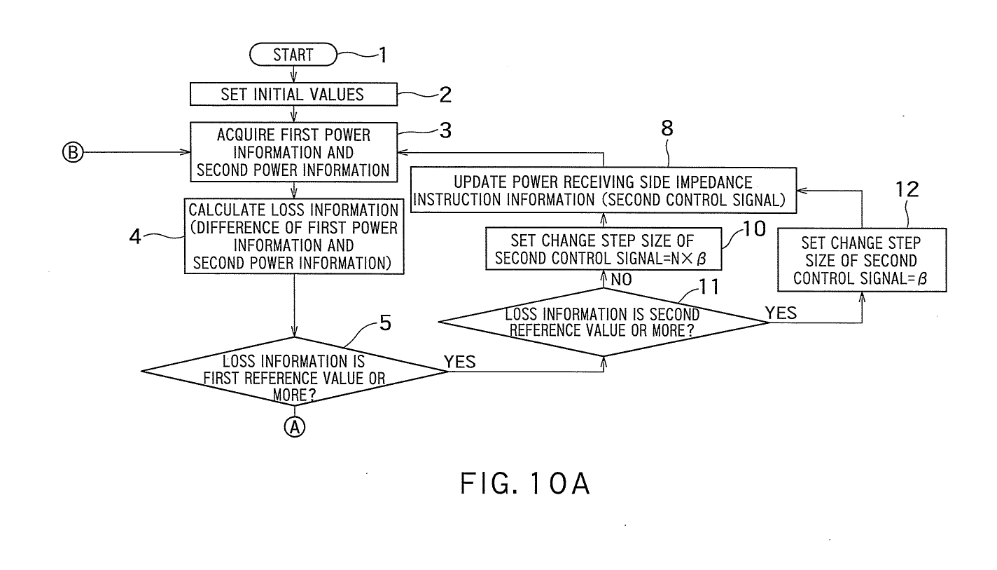

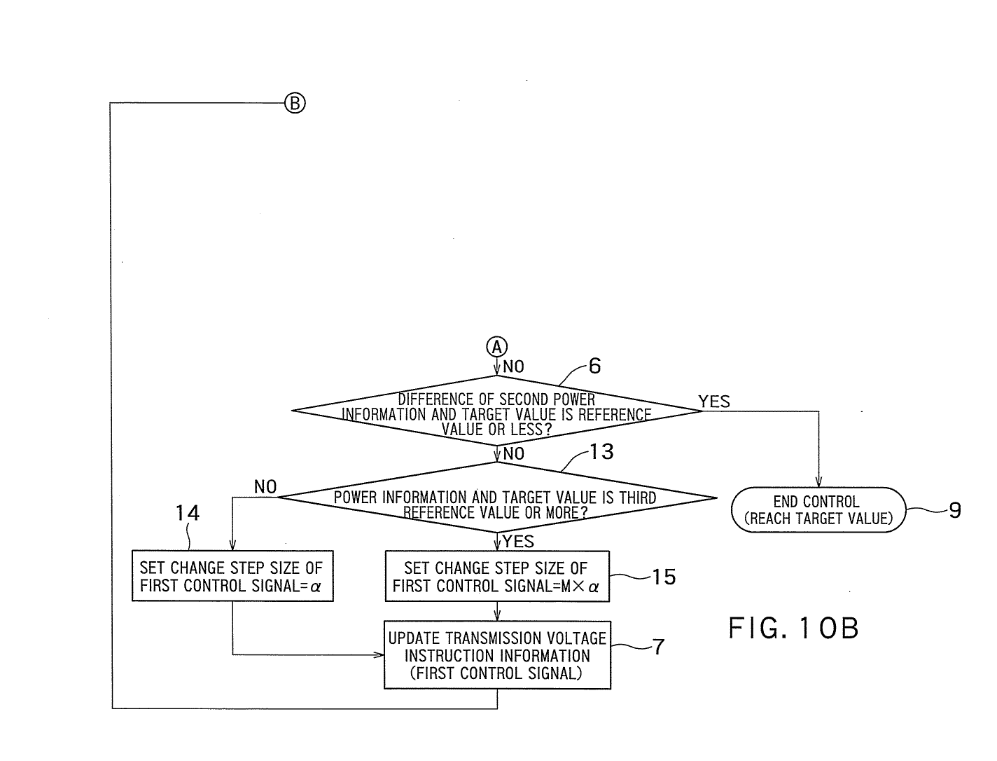

A third embodiment will be described with use of FIGS. 10A and 10B.

FIGS. 10A and 10B show an operation flow of a wireless power transmission controller according to the present embodiment. The same steps as in FIG. 4 are assigned with the same reference signs, and the redundant description will be omitted.

The present embodiment has steps 14 and 15 that change a step size (change amount) at a time of changing the first control signal, and steps 10 and 12 that change a step size at a time of changing the second control signal, in addition to the operation of the first embodiment.

In step 5 of FIG. 10A, comparison with loss information is performed with use of a first reference value. If the loss information is the first reference value or more, it is determined whether the loss information is a second reference value or more next (step 11). The second reference value is a value larger than the first reference value. If the loss information is the second reference value or more, the step size at the time of changing the second control signal is set at “β” (step 12), whereas if the loss information is smaller than the second reference value, the step size at the time of changing the second control signal is set at “N×β” (step 12). “N” is an optional real number larger than 1. Namely, as the loss is larger, the step size is set to be smaller. The second reference value is assumed to be set with a predetermined margin with respect to the loss which the device can allow. When the loss is larger than the second reference value, the loss is close to the allowable value of the device, and therefore, if change is made with a large step size, the loss is likely to exceed the allowable value. Therefore, when the loss is the second reference value or more, the step size is finely set in step 12. Conversely, if the loss is smaller than the second reference value, the risk of the loss exceeding the allowable value of the device is small even if change is made with a rough step size, and therefore, change with a rough step size is performed in step 10.

In step 6, a difference between the second power information and a target value is compared with a reference value. If the difference is the reference value or more, the difference is compared with a third reference value next (step 13). The third reference value is a value larger than the reference value which is used in step 6. If the difference is the third reference value or more, the step size at the time of changing the first control signal is set at “M×α” (step 15), whereas if the difference is smaller than the third reference value, the step size is set at “α” (step 14). “N” is an optional real number larger than 1. Namely, when the difference is smaller than the third reference value, the second power information is close to the target value, and therefore, if change is made with a rough step size, the second power information is likely to exceed the target value. Therefore, the step size is made small in step 14.

As above, when the loss information is smaller than the second reference value, the step size of change of the second control signal becomes large. Further, when the above described difference is larger than the third reference value, the step size of change of the first control signal becomes large. Therefore, the raising control of transmission power (start-up of the power transmitting device) can be finished in a shorter time.

FIGS. 10A and 10B show the case of making the step size of the second control signal large when the loss information is smaller than the second reference value, but a case in which the reception power information is smaller than a reference value may be used as the determination reference. Further, similarly, a case in which the transmission power information is smaller than a reference value may be set as the determination reference.

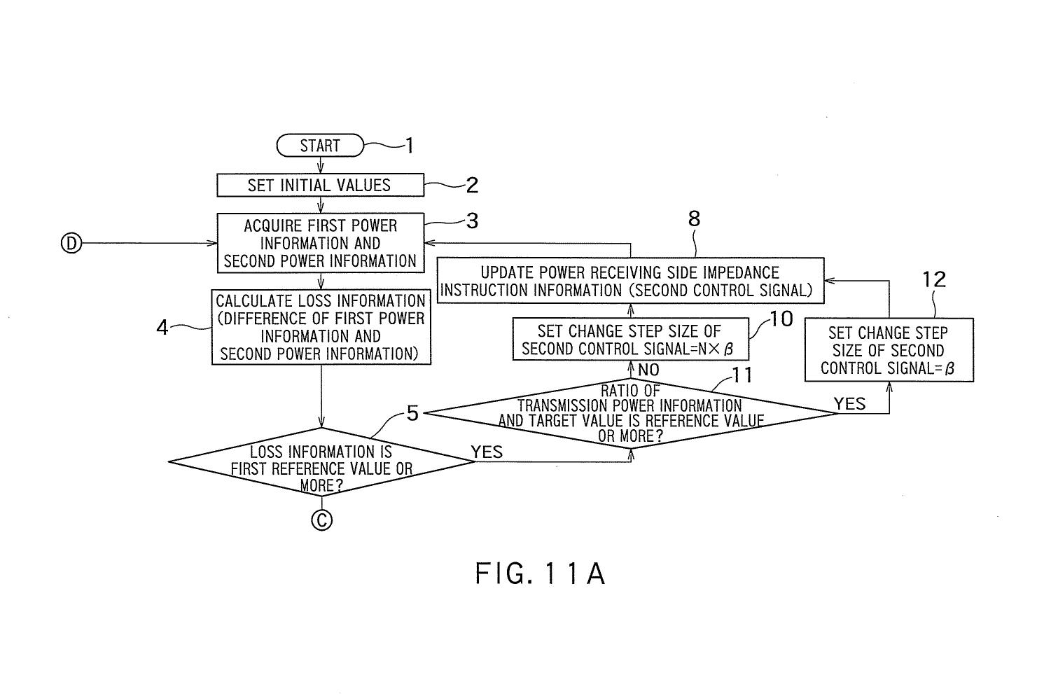

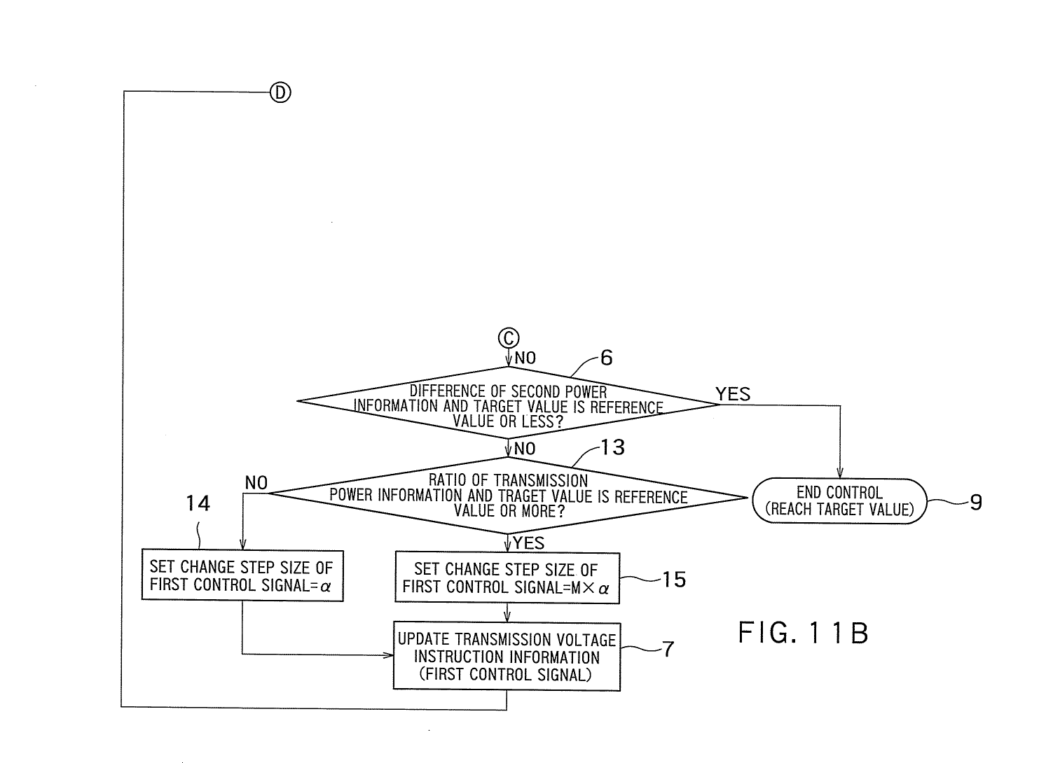

FIGS. 11A and 11B show a flowchart in which the operations of steps 11 and 13 of FIGS. 10A and 10B are changed. The steps other than steps 11 and 13 are similar to FIGS. 10A and 10B. As shown in steps 11 and 13 of FIGS. 11A and 11B, it may be determined whether or not a ratio of the transmission power information and a target value is a reference value or more. When the ratio is determined as the reference value or more in step 11, the step size is set at “β”, whereas when the ratio is determined as smaller than the reference value, the step size is set at “N×β”. Further, when the ratio is determined as the reference value or more in step 13, the step size is set at “α”, whereas when the ratio is determined as smaller than the reference value, the step size is set at “M×α”. Note that the reference values used in steps 11 and 13 may be the same value, or may be different values.

Similarly, a ratio of the reception power information and the target value may be used as the determination reference. Further, a ratio of the difference between the transmission power information and the reception power information, and a target value of the transmission power may be used as the determination reference. Alternatively, a ratio of the difference between the transmission power information and the reception power information, and a target value of the reception power may be used as the determination reference.

Other than the above, any parameter with which the loss, the current, the voltage and the like can be detected as values that are low by certain degrees or more can be used as the determination reference based on which the step size is changed.

FIGS. 10A and 10B and FIGS. 11A and 11B show the case of changing the step sizes for both the first and the second control signals, but a configuration that changes the step size of only any one of them may be adopted.

Further, FIGS. 10A and 10B and FIGS. 11A and 11B show the case having two kinds of settable step sizes, but three kinds or more of step sizes are made settable by providing a plurality of determination references.

### Fourth Embodiment

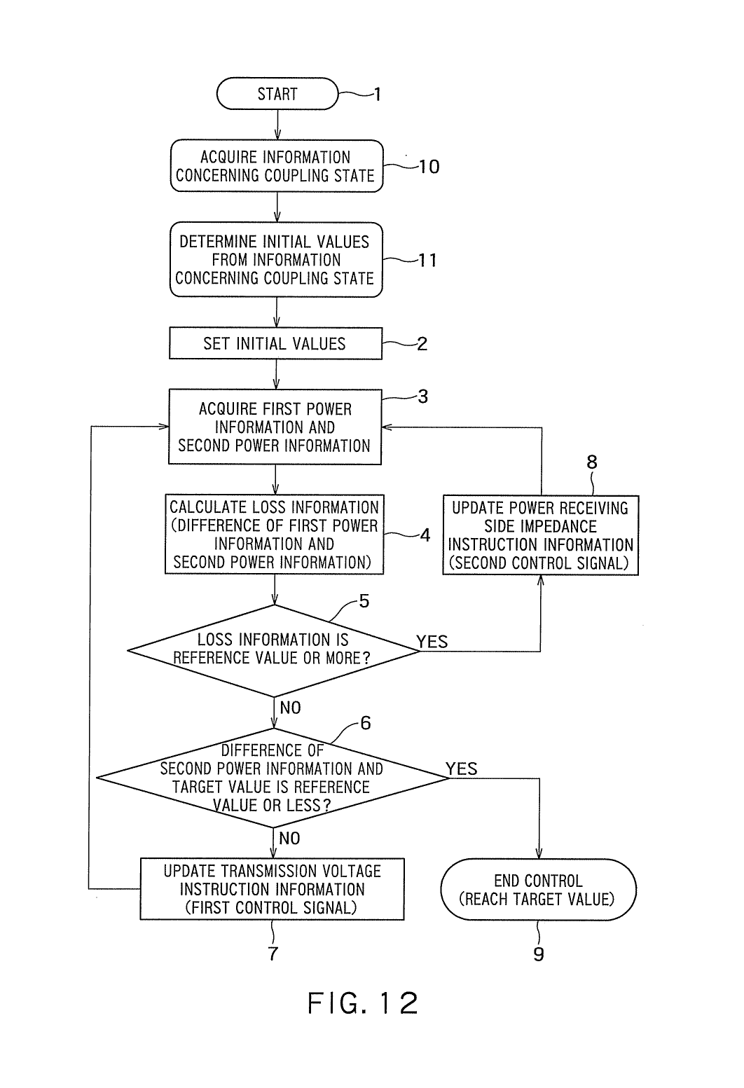

A fourth embodiment will be described with use of FIG. 12.

FIG. 12 shows an operation flow of a wireless power transmission controller according to the present embodiment. The same steps as in FIG. 4 are assigned with the same reference signs, and the redundant description will be omitted.

The present embodiment has step 10 of performing acquisition of information relating to a coupling state of the power transmitting unit and the power receiving unit, and step 11 of determining the initial values of the first control signal and the second control signal based on the acquired information, before the initial values of the first and the second control signals are set. As the coupling state, for example, a coupling coefficient, a positional relationship between the power transmitting coil and the power receiving coil and the like are cited. In step 11 that determines the initial values, the initial values may be derived with use of predetermined calculation formulas, or may be derived with use of a lookup table that is prepared in advance.

In determination of the initial values, a plurality of kinds of information other than the information relating to the coupling state may be used. For example, a resonance frequency of the power transmitting unit, a resonance frequency of the power receiving unit, a power transmission frequency, a state of the load and the like may be used.

Thereby, the raising control of transmission power can be finished in a shorter time.

### Fifth Embodiment

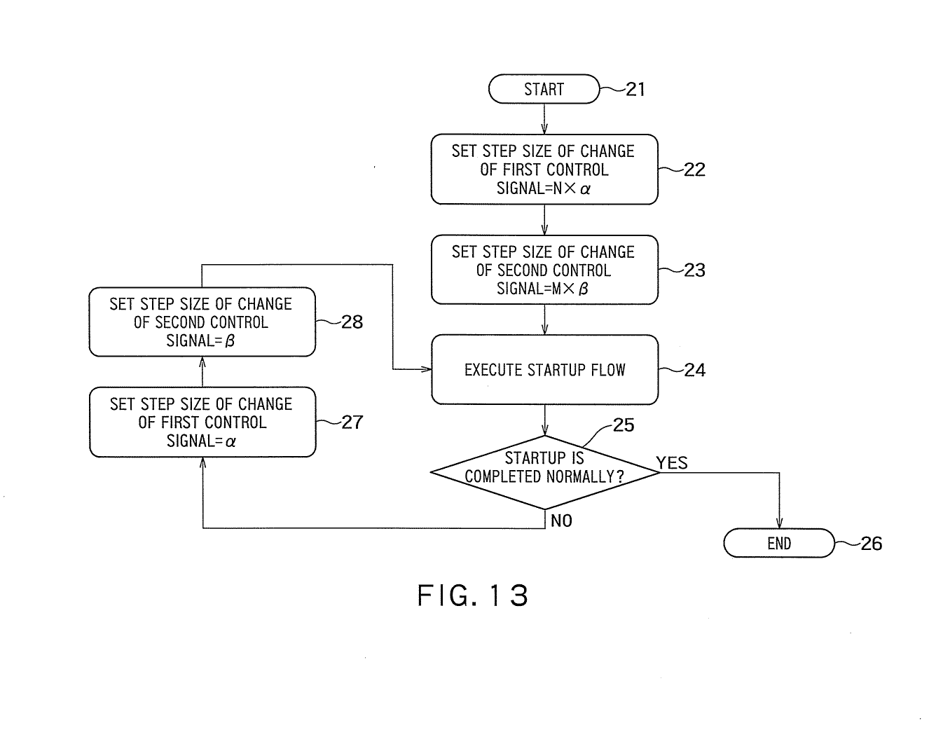

A fifth embodiment will be described with use of FIG. 13.

FIG. 13 shows an operation flow of a wireless power transmission controller according to the present embodiment.

First, at a time of start (step 21), change step sizes of the first control signal and the second control signal are respectively set at “N×α”, and “M×β” (steps 22 and 23). “N” and “M” are real numbers larger than 1.

Thereafter, a raising flow is executed (step 24). Here, the raising flow means the flow of the start-up control of the power transmitting device shown in FIG. 4, for example.

Determination of whether the execution of the raising flow is normally finished is performed (step 25). Here, the case in which the execution is not finished normally means occurrence of various events such as a stop due to the current at the power transmitting side or the power receiving side exceeding an allowable amount, a stop due to the voltage at the power transmitting side or the power receiving side exceeding an allowable amount, and the raising control being not finished in a predetermined time, for example.

If the execution of the raising flow is normally finished, the processing of the present flow is finished (step 26), and if the execution of the raising flow is not normally finished, the change step sizes of the first and the second control signals are respectively changed to “α” and “β” (steps 27 and 28), and execution of the raising flow is performed again.

By performing the processing like this, in the case in which a failure occurs due to the step size of the control signal being large, the failure is likely to be avoidable by making the step size of the control signal small.

Note that a configuration which performs change of the step size for only any one of the first and the second control signals may be adopted.

### Sixth Embodiment

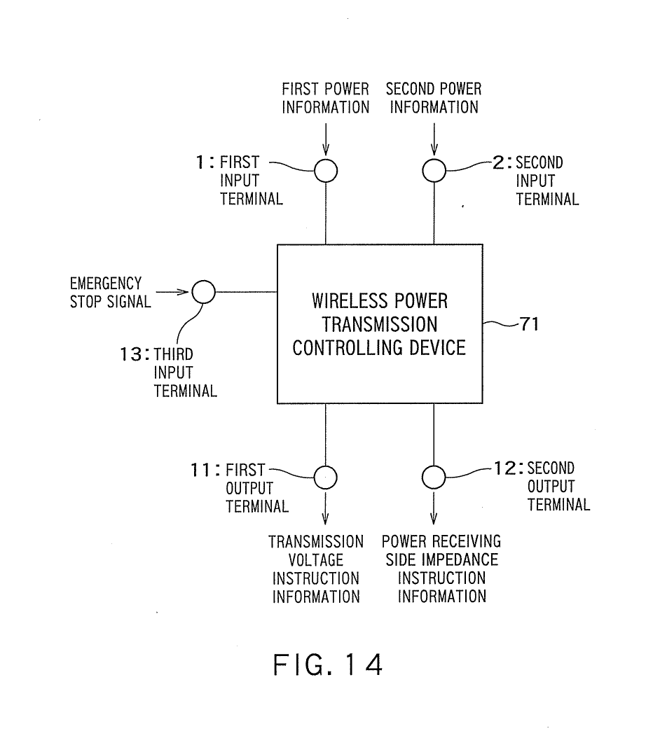

FIG. 14 shows a wireless power transmission controller according to a sixth embodiment. The wireless power transmission controller of FIG. 14 has a third input terminal 13 as an emergency stop signal inputting device in which an emergency stop signal is inputted, in addition to the first embodiment shown in FIG. 1. The same elements as in FIG. 1 are assigned with the same reference signs.

A wireless power transmission controlling device 71 executes the raising control operation shown in FIG. 4, similarly to the first embodiment. A difference from the first embodiment lies in that when the emergency stop signal is inputted from the third input terminal 13 during execution of the raising control operation, the wireless power transmission controlling device 71 stops the raising control operation. Thereby, an emergency stop can be performed at a time of occurrence of abnormalities such as a temperature of the power transmitting unit or the power receiving unit reaching a threshold value or more, the voltage/current of the device significantly varying, and communication being disconnected.

### Seventh Embodiment

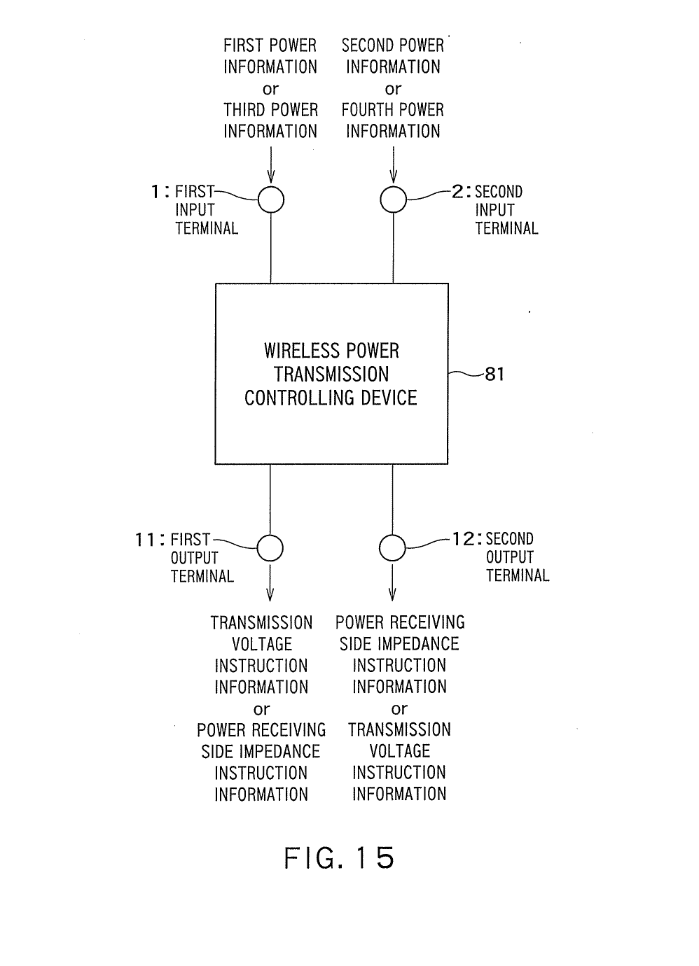

FIG. 15 shows a wireless power transmission controller according to a seventh embodiment.

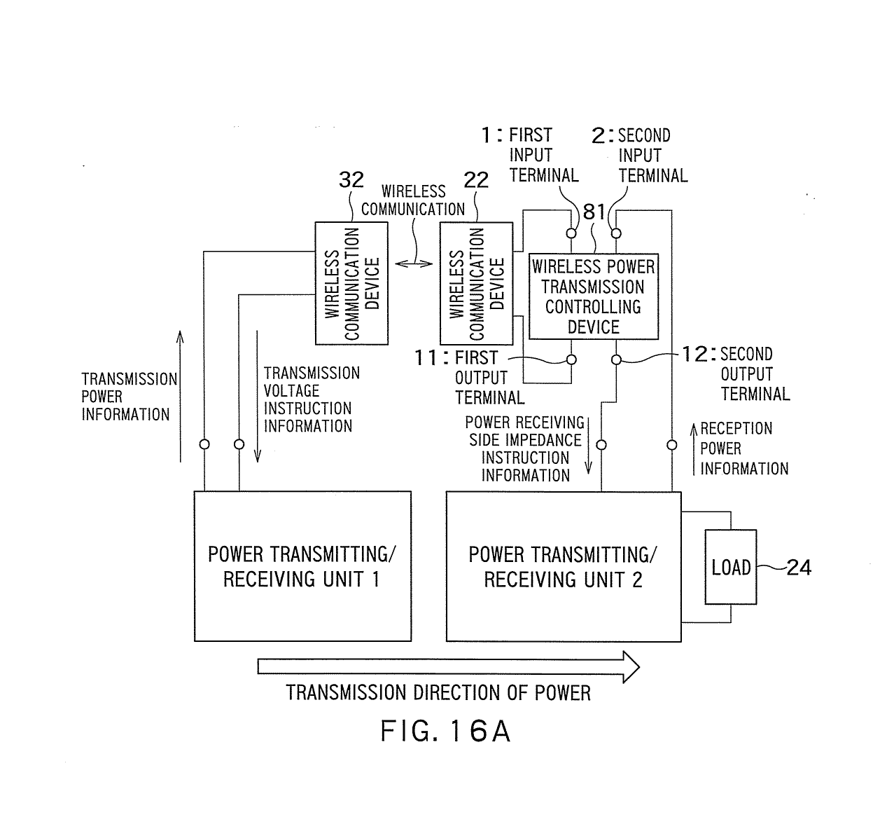

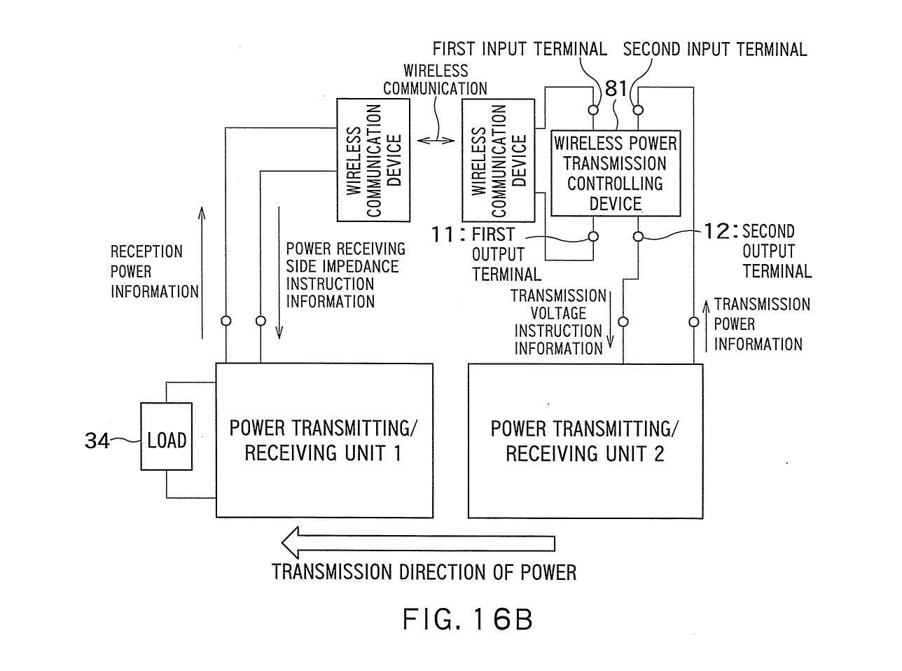

The wireless power transmission controller shown in FIG. 1 is used in the system shown in FIG. 2 or FIG. 3. In the system, the device at the one side performs only power transmission, and the device at the other side performs only power reception. In contrast with this, the wireless power transmission controller shown in FIG. 15 can be used in a system as shown in FIGS. 16A and 16B in which a relationship of power transmission and power reception is not fixed between the two devices.

As shown in FIGS. 16A and 16B, the present system includes a first power transmitting/receiving device, and a second power transmitting/receiving device. The first power transmitting/receiving device includes a power transmitting/receiving unit 1 capable of both transmission and reception of power and a wireless communicating device 32. The second power transmitting/receiving device includes a power transmitting/receiving unit 2 capable of both transmission and reception of power, a wireless power transmission controlling device 81, the wireless communicating device 22, the first input terminal 1, the second input terminal 2, the first output terminal 11 and the second output terminal 12. The wireless communicating device 22 is connected to the first input terminal 1 and the first output terminal 11, and the power transmitting/receiving unit 1 is connected to the first input terminal 1 and the first output terminal 11 via the wireless communicating devices 32 and 22.

In the present example, the wireless power transmission controlling device is provided at the second power transmitting/receiving device, but may be provided at the first power transmitting/receiving device. In this case, the wireless communicating device 32 is connected to the second input terminal 2 and the second output terminal 12, and the power transmitting/receiving unit 2 is connected to the second input terminal 2 and the second output terminal 12 via the wireless communicating devices 32 and 22.

FIG. 16A shows a case in which the power transmitting/receiving unit 1 is used as a power transmitting unit, and the power transmitting/receiving unit 2 is used as a power receiving unit. In this case, transmission power information (first power information) of the power transmitting/receiving unit 1 is inputted in the first input terminal 1, and reception power information (second power information) of the power transmitting/receiving unit 2 is inputted in the second input terminal 2. Further, from the first output terminal 11, transmission voltage instruction information to the power transmitting/receiving unit 1 is outputted, and power receiving side impedance instruction information to the power transmitting/receiving unit 2 is outputted from the second output terminal 12. Note that the power which is supplied to the power transmitting/receiving unit 2 is consumed or accumulated in the load 24.

FIG. 16B shows a case in which the power transmitting/receiving unit 2 is used as the power transmitting unit, and the power transmitting/receiving unit 1 is used as the power receiving unit. In this case, reception power information (third power information) of the power transmitting/receiving unit 1 is inputted in the first input terminal 1, and transmission power information (fourth power information) of the power transmitting/receiving unit 2 is inputted in the second input terminal 2. Further, the power receiving side impedance instruction information is outputted to the power transmitting/receiving unit 1 from the first output terminal 11, and the transmission voltage instruction information is outputted to the power transmitting/receiving unit 2 from the second output terminal 2. Note that the power which is supplied to the power transmitting/receiving unit 1 is consumed or accumulated in the load 34.

### Eighth Embodiment

In the first to the seventh embodiments, the wireless power transmission controlling device 21 is provided with the four terminals, that is, the first input terminal 1 which receives the first power information, the second input terminal 2 which receives the second power information, the first output terminal 11 which outputs the transmission voltage instruction information, and the second output terminal 12 which outputs the power receiving side impedance instruction information (see FIG. 1). The four-terminal configuration like this is only an example, and other terminal configurations are also enabled.

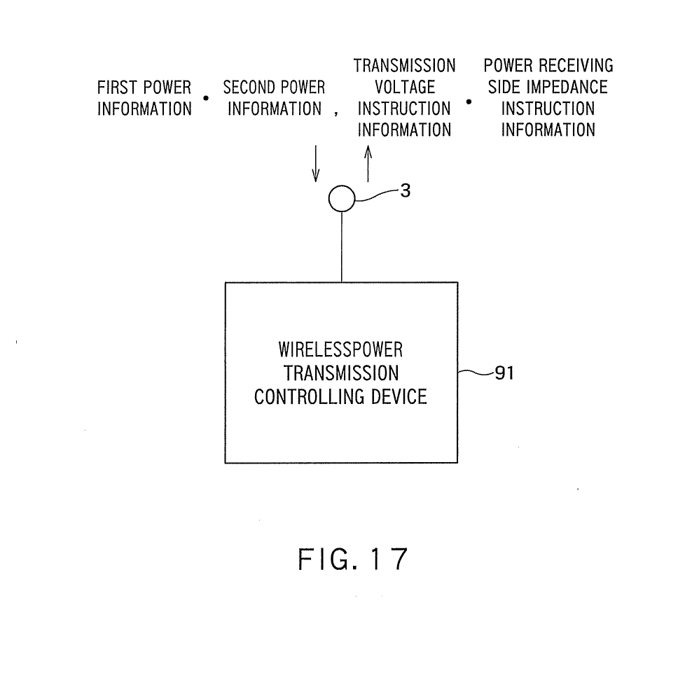

FIG. 17 shows a configuration in which the four terminals shown in FIG. 1 are combined into one input/output terminal 3. In this configuration, the one input/output terminal 3 is provided at a wireless power transmission controlling device 91. The first power information and the second power information are received with the one input/output terminal 3, and the transmission voltage instruction information and the power receiving side impedance instruction information are outputted from the one input/output terminal 3. These kinds of information which are transmitted and received are assigned with notification information such as headers (hereinafter, unified as a header) at the transmitting side, and the headers are analyzed at the receiving side of the information, whereby acceptance and rejection of the information are performed at the receiving side. Namely, the receiving side acquires necessary information from the received information by analyzing the headers. The unnecessary information may be discarded. Certain arrangement can be made in advance for the rule governing writing to the headers.

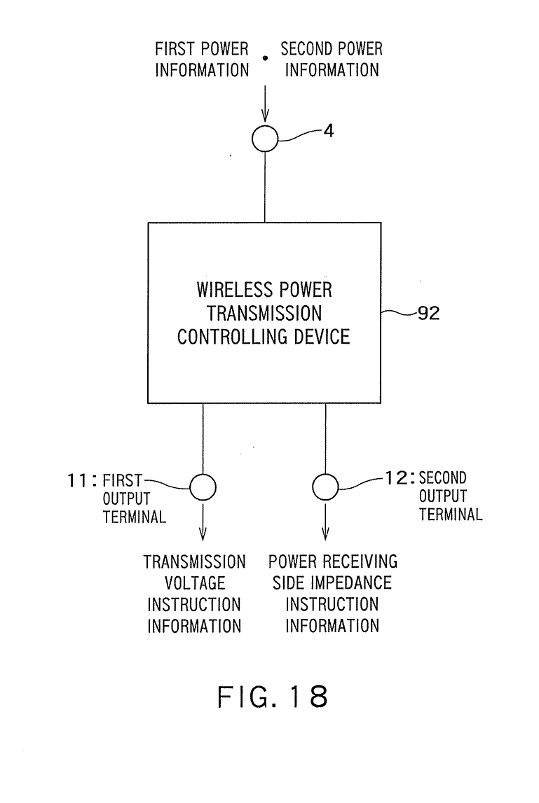

FIG. 17 shows the configuration in which all the four terminals are combined into one, but a configuration in which only the two terminals at the input side are combined into one can be adopted. The configuration is shown in FIG. 18. The two terminals at the input side are combined into one input terminal 4. The output side has a two-terminal configuration similarly to FIG. 1. The first power information and the second power information are received with the one input terminal 4. The header generated based on the rule arranged in advance is assigned to the information at the transmitting side, and at the receiving side (wireless power transmission controlling device 92), the header assigned to the received information is analyzed, whereby necessary information (the first power information or the second power information) is identified and acquired, from the received information. When unnecessary information is received, the information can be discarded.

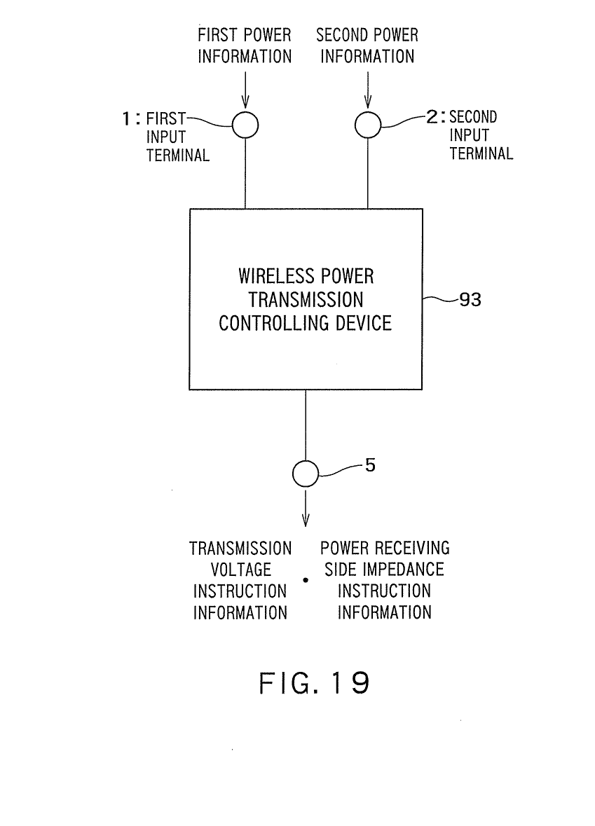

FIG. 19 shows a configuration in which the two terminals at the output side are combined into one. The two terminals at the output side are combined into one output terminal 5. The input side has a two-terminal configuration similarly to FIG. 1. The transmission voltage instruction information and the power receiving side impedance instruction information are outputted with the one output terminal 5. A wireless power transmission controlling device 93 assigns a header created based on the rule arranged in advance to the information to be transmitted. At the receiving side, the header assigned to the information is analyzed, and thereby the necessary information (the transmission voltage instruction information or the power receiving side impedance instruction information) is identified and acquired from the received information.

Further, the configuration of FIG. 18 and the configuration of FIG. 19 are combined, the two terminals at the input side are combined into one, and the two terminals at the output side also can be combined into one. In this case, a two-terminal configuration in which the input side has one input terminal and the output side has one output terminal is established.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A wireless power transmission controller, comprising:
an input device to receive first power information from a power transmitting device, the first power information indicating electric power transmitted by the power transmitting device, and second power information from a power receiving device, the second power information indicating electric power received by the power receiving device;
an output device to output a first control signal that instructs a transmission voltage of the power transmitting device, and a second control signal that instructs an impedance of the power receiving device; and
a control device to perform raising control of transmission power of the power transmitting device by generating the second control signal and the first control signal,
wherein the control device generates the second control signal so that a difference between the first power information and the second power information becomes small, and generates the first control signal so that a difference between the first power information and a first target value or a difference between the second power information and a second target value becomes small.

2. The controller according to claim 1,
wherein the control device changes the first control signal to increase the transmission voltage when the first power information is smaller than the first target value, or when the second power information is smaller than the second target value, and
changes the first control signal to decrease the transmission voltage when the first power information is larger than the first target value, or when the second power information is larger than the second target value.

3. The controller according to claim 1,
wherein the control device changes the second control signal so as to sequentially increase or decrease the impedance.

4. The controller according to claim 1,
wherein the control device receives information of at least one or more of a voltage of the power transmitting device, a current of the power transmitting device, a voltage of the power receiving device, and a current of the power receiving device, and
when the voltage or the current is larger than a threshold value, the control device changes the second control signal so that the voltage or the current becomes small.

5. The controller according to claim 1,
wherein the input device and the output device are one input/output terminal that receives the first power information and the second power information, and outputs the first and the second control signals.

6. The controller according to claim 1,
wherein the input device is one input terminal that receives the first power information and the second power information.

7. The controller according to claim 1,
wherein the output device is one output terminal that outputs the first and the second control signals.

8. The controller according to claim 1,
wherein the input device includes a first input terminal that receives the first power information, and a second input terminal that receives the second power information, and
the output device includes a first output terminal that outputs the first control signal, and a second output terminal that outputs the second control signal,
the wireless power transmission controller further comprising:
a wireless communicating device connected to the first input terminal and the first output terminal, and perform wireless communication with the power transmitting device.

9. The controller according to claim 1,
wherein the input device includes a first input terminal that receives the first power information, and a second input terminal that receives the second power information, and
the output device includes a first output terminal that outputs the first control signal, and a second output terminal that outputs the second control signal,
the wireless power transmission controller further comprising:
a wireless communicating device connected to the second input terminal and the second output terminal, and perform wireless communication with the power receiving device.

10. The controller according to claim 1,
wherein the input device receives information indicating at least one of the transmission voltage and a transmission current of the power transmitting device, and
the control device changes the second control signal so that the transmission voltage or the transmission current becomes smaller than each reference value.

11. The controller according to claim 1,
wherein the input device receives information indicating at least one of a reception voltage and a reception current of the power receiving device, and
the control device changes the second control signal so that the reception voltage or the reception current becomes smaller than each reference value.

12. The controller according to claim 1,
wherein the control device changes the first control signal so as to sequentially increase or decrease the transmission voltage, and sets a change amount of the first control signal to become smaller as a difference of the first power information and the second power information is larger.

13. The controller according to claim 1,
wherein the control device changes the first control signal so as to sequentially increase or decrease the transmission voltage, and sets a change amount of the first control signal to become smaller as a ratio of power indicated by the first power information to a target value is larger.

14. The controller according to claim 1,
wherein the control device changes the second control signal so as to sequentially increase or decrease the impedance, and determines a change amount of the second control signal to become smaller as a difference of the first power information and the second power information is larger.

15. The controller according to claim 1,
wherein the control device changes the second control signal so as to sequentially increase or decrease the impedance, and sets a change amount of the second control signal to become smaller as a ratio of power indicated by the first power information to a target value is larger.

16. The controller according to claim 1,
wherein the control device increases or decreases the first control signal by a first step size, and increases or decreases the second control signal by a second step size, and
when the control device fails in the raising control, the control device makes values of the first step size and the second step size small, and executes the raising control again.

17. The controller according to claim 1,
wherein the control device sets an initial value of at least one of the first control signal and the second control signal based on a positional relationship between a power transmitting coil of the power transmitting device and a power receiving coil of the power receiving device, or a coupling coefficient between the power transmitting coil and the power receiving coil.

18. The controller according to claim 1,
wherein the control device sets an initial value of at least one of the first control signal and the second control signal based on a state of a load that is connected to the power receiving device.

19. The controller according to claim 1, further comprising:
an emergency stop signal inputting device to receive an emergency stop signal,
wherein the control device stops the raising control when the emergency stop signal is received in the emergency stop signal inputting device.

20. A power transmitting device, comprising:
a power transmitting unit to transmit power;
an input device to receive first power information indicating power transmitted from the power transmitting unit;
an output device to output a first control signal that instructs a transmission voltage to the power transmitting unit;
a wireless communicating device to receive second power information indicating power that a power receiving device receives from the power transmitting unit, from the power receiving device, and transmit a second control signal that instructs an impedance of the power receiving device to the power receiving device; and
a control device to perform raising control of transmission power of the power transmitting unit by generating the second control signal and the first control signal,
wherein the control device generates the second control signal so that a difference between the first power information and the second power information becomes small, and generates the first control signal so that a difference between the first power information and a first target value or a difference between the second power information and a second target value becomes small.

21. A power receiving device, comprising:
a power receiving unit to receive power from a power transmitting device;
a wireless communicating device to receive first power information indicating power transmitted from the power transmitting device, from the power transmitting device, and transmits a first control signal instructing a transmission voltage to the power transmitting device;
an input device to receive second power information indicating power that the power receiving unit receives from the power transmitting device;
an output device to output a second control signal instructing an impedance of the power receiving unit to the power receiving unit; and
a control device to perform raising control of transmission power of a power transmitting unit by generating the second control signal and the first control signal,
wherein the control device generates the second control signal so that a difference between the first power information and the second power information becomes small, and generates the first control signal so that a difference between the first power information and a first target value or a difference between the second power information and a second target value becomes small.

22. A wireless power transmitting system, comprising:
a power transmitting device including a power supply that generates power with a transmission voltage changeable, and a power transmitting coil that transmits the power;
a power receiving device including a power receiving device that receives power from the power transmitting coil, a variable impedance circuit, and a load that consumes or accumulates the power received via the variable impedance circuit; and
a wireless power transmission controller to perform raising control of transmission power of the power transmitting device,
wherein the wireless power transmission controller includes
an input device that receives first power information indicating power transmitted from the power transmitting device, and second power information indicating power that the power receiving device receives from the power transmitting device, and
an output device that outputs a first control signal that instructs a transmission voltage of the power transmitting device, and a second control signal that instructs an impedance of the variable impedance circuit,
generates the second control signal so that a difference between the first power information and the second power information becomes small, and
generates the first control signal so that a difference between the first power information and a first target value or a difference between the second power information and a second target value becomes small.

23. The system according to claim 22,
wherein the variable impedance circuit is a DC-DC converter.

24. The system according to claim 22,
wherein the load is a storage battery.

25. The system according to claim 22,
wherein the first target value or the second target value is set based on power that can be outputted of the power transmitting device.

26. The system according to claim 22,
wherein the power receiving device notifies instruction information relating to the first target value or the second target value, to the wireless power transmission controller and
the wireless power transmission controller sets the first target value or the second target value based on the instruction information.

27. The system according to claim 22,
wherein the wireless power transmission controller sets the first target value or the second target value based on instruction information notified by a power management system that manages the power transmitting device or the power receiving device.

28. A wireless power transmission controller that controls power transmission between a first power transmitting/receiving device and a second power transmitting/receiving device, comprising:
an input device;
an output device; and
a control device,
wherein in a first transmission mode that transmits power from the first power transmitting/receiving device to the second power transmitting/receiving device,
the input device receives first power information indicating power transmitted from the first power transmitting/receiving device, and receives second power information indicating power that the second power transmitting/receiving device receives from the first power transmitting/receiving device,
the output device outputs a first control signal that instructs a transmission voltage of the first power transmitting/receiving device, and outputs a second control signal that instructs an impedance of the second power transmitting/receiving device, and
the control device performs raising control of transmission power of the first power transmitting/receiving device by generating the second control signal and the first control signal,
wherein the control device generates the second control signal so that a difference between the first power information and the second power information becomes small, and generates the first control signal so that a difference between the first power information and a first target value or a difference between the second power information and a second target value becomes small; and
in a second transmission mode that transmits power from the second power transmitting/receiving device to the first power transmitting/receiving device,
the input device receives third power information indicating power transmitted from the second power transmitting/receiving device, and receives fourth power information indicating power that the first power transmitting/receiving device receives from the second power transmitting/receiving device,
the output device outputs a third control signal that instructs a transmission voltage of the second power transmitting/receiving device, and outputs a fourth control signal that instructs an impedance of the first power transmitting/receiving device, and
the control device performs raising control of transmission power of the second power transmitting/receiving device by generating the fourth control signal and the third control signal,
wherein the control device generates the second control signal so that a difference between the third power information and the fourth power information becomes small, and generates the third control signal so that a difference between the third power information and a third target value or a difference between the fourth power information and a fourth target value becomes small.

29. The controller according to claim 28, further comprising:
a wireless communicating device,
wherein the input device includes a first input terminal that receives the first power information and the fourth power information, and a second input terminal that receives the second power information and the third power information,
the output device includes a first output terminal that outputs the first and the fourth control signals, and a second output terminal that outputs the second and the third control signals, and
the wireless communicating device is connected to the first input terminal and the first output terminal, and performs wireless communication with the first power transmitting/receiving device.

30. The controller according to claim 29, further comprising:
the second power transmitting/receiving device.

31. The controller according to claim 28, further comprising:
a wireless communicating device,
wherein the input device includes a first input terminal that receives the first power information and the fourth power information, and a second input terminal that receives the second power information and the third power information,
the output device includes a first output terminal that outputs the first and the fourth control signals, and a second output terminal that outputs the second and the third control signals, and
the wireless communicating device is connected to the second input terminal and the second output terminal, and performs wireless communication with the second power transmitting/receiving device.

32. The controller according to claim 31, further comprising:
the first power transmitting/receiving device.

33. A wireless power transmitting device having a power transmitting device, a power receiving device, and a control device, comprising:
a resonator including a coil and a capacitance in the power transmitting device;
a resonator including a coil and a capacitance in the power receiving device;
a device to detect at least one of a voltage and a current of the resonator in the power transmitting device;
a device to detect at least one of a voltage and a current of the resonator in the power receiving device;
a device to change a transmission voltage of the power transmitting device; and
a device to change an impedance of the power receiving device,
wherein the control device performs raising control of the power transmitting device by controlling change of the transmission voltage of the power transmitting device and the impedance of the power receiving device.
